(19) United States
(12) Patent Application Publication
(10) Pub. No.: US 2013/0317898 A1
(43) Pub. Date: Nov. 28, 2013

(54) REDEEMING COUPONS WITH A VISUAL PATTERN ON A MOBILE DEVICE

(71) Applicants: ROBERT KIM, Toronto (CA); Ray Reddy, Toronto (CA)

(72) Inventors: ROBERT KIM, Toronto (CA); Ray Reddy, Toronto (CA)

(73) Assignee: GOOGLE Inc., Mountain View, CA (US)

(21) Appl. No.: 13/478,993

(22) Filed: May 23, 2012

(51) Int. Cl. G06Q 30/02

(52) U.S. Cl. 705/14.26; 705/14.1

(57) ABSTRACT

The invention involves using a visual verification pattern on a mobile device to redeem a coupon. A user installs a coupon presentation application on a user device and configures an account and downloads and stores coupons on the application. The user approaches a point of sale terminal at a merchant location to purchase a product. The user accesses the coupon and indicates to the coupon distribution system that distributed the coupon that a purchase is imminent and a verification of a coupon will be required. The system accesses the coupon visual verification pattern configured by the merchant and transmits the pattern to the application. The application displays the pattern on the mobile device display for presentation to the merchant. The merchant can recognize the visual verification pattern and enter the discount or rebate associated with the coupon into the terminal along with the purchase details.

### TECHNICAL FIELD

The present disclosure relates generally to electronic coupons, and more particularly to systems and methods to use a visual verification pattern on a mobile device to redeem a coupon.

### BACKGROUND

Shoppers are obtaining an increasing number of coupons via the Internet or other online sources. The coupons may be emailed to the user, delivered via text, downloaded from websites, transmitted via banner ads or popup ads, or received in many other electronic formats. Many of the coupons, even though obtained online, are redeemed offline in a physical merchant location.

A “coupon” may represent any type of rebate, discount, purchase reward, prepaid offer, or any other type of redeemable offer that may provide an incentive for a user to purchase a product. “Product(s)” can include tangible and intangible products, as well as services.

Users have had several options to redeem a coupon such as printing out the coupon or handing the mobile device displaying the coupon to the merchant for verification. Printing out a coupon that was received on a mobile device can be very cumbersome for the user. Additionally, many users find handing a mobile device to a merchant to be needlessly intrusive.

Unfortunately, the merchant may require a manner of verifying the data on the coupon. For example, the merchant must ensure that the coupon is not expired and that the user's purchase meets the requirements of the coupon to receive the rebate or discount. Without a manner of validating the coupon data, the merchant may be subject to errors, inefficiencies, or outright fraud.

Another attempt to improve the verification process requires the user to speak a word or phrase to the merchant. This process may be effective in an isolated environment, but the potential for fraud is great. A second user would only need to overhear the phrase to gain access to the coupon. The merchant may be unable to control or limit the number of coupon redeemers as the phrase is passed from user to user.

### SUMMARY

The present invention provides a computer-implemented method to use a visual verification pattern on a mobile device to redeem a coupon. A user installs a coupon presentation application (“CPA”) on a user device and configures an account. A user downloads and stores coupons on the CPA. The user approaches a point of sale (“POS”) terminal at a merchant location to purchase a product. The user accesses the coupon and indicates to the coupon distribution system (“CDS”) that distributed the coupon that a purchase is imminent and a verification of a coupon will be required. The CDS accesses the coupon visual verification pattern configured by the merchant and transmits the pattern to the CPA. The CPA displays the pattern on the mobile device display for presentation to the merchant. The merchant can recognize the visual verification pattern and enter the discount or rebate associated with the coupon into the POS terminal along with the purchase details.

Another aspect of the present invention provides a computer program product that is installed on a server located in a CDS to use a visual verification pattern on a mobile device to redeem a coupon. The computer program product includes a non-transitory computer-readable storage device having computer-readable program instructions stored therein. The computer-readable program instructions include computer program instructions for receiving a request to supply a coupon verification pattern; identifying the location of the device; offering a user a choice of any coupons stored by the user that correspond to that location; receiving a coupon selection; accessing the stored visual verification pattern associated with the selected coupon by the merchant; transmitting visual verification pattern to the user device; and receiving acknowledgement of the coupon redemption from the merchant POS terminal.

Another aspect of the present invention provides a system to use a visual verification pattern on a mobile device to redeem a coupon. The system includes a CPA located on a user's mobile device and logically coupled to a digital wallet application. The system also includes a server, which may be operating on a CDS, and a merchant system. The CPA may be configured to download and store coupons and receive and display the visual verification pattern. The CDS server may be configured to receive a coupon selection; access the stored visual verification pattern associated with the selected coupon by the merchant; transmit the visual verification pattern to the user device; and receive acknowledgement of the coupon redemption from the merchant POS terminal.

### BRIEF DESCRIPTION OF THE DRAWINGS

FIG. 1 is a block diagram depicting a system for using a visual pattern for coupon redemption via a mobile device, in accordance with certain exemplary embodiments.

FIG. 2 is a block flow diagram depicting a method to use a visual pattern for coupon redemption via a mobile device, in accordance with certain exemplary embodiments.

FIG. 3 is a block flow diagram depicting a method for a merchant to issue and redeem a coupon using a visual pattern, in accordance with certain exemplary embodiments.

### DETAILED DESCRIPTION OF THE EXEMPLARY EMBODIMENTS

### Overview

The present invention provides a computer-implemented method to use a visual verification pattern on a mobile device to redeem a coupon. A user may install a digital wallet coupled to a coupon presentation application (“CPA”). The digital wallet and the CPA may be embodied as applications operating on a device of the user, a cloud computing environment, or a combination of the two.

A user downloads and stores coupons on the CPA. The user may obtain the coupons through any available means for acquiring coupons. The coupons may be from an online advertisement such as a banner ad or a popup ad. The coupons may be from a pre-pay or daily deal coupon distributor. The coupons may be received via email, text, instant message or some other coupon distribution technology. The coupons may be stored on the CPA residing on the phone, on the user's account on the CDS, or on the cloud computing environment.

A user can visit a physical merchant location and select a product for which a coupon is associated. The user can initiate the CPA to access the coupon. In certain exemplary embodiments of the invention, the CPA can transmit the location of the user to a coupon distribution system (“CDS”) and the CDS can identify a coupon or a list of coupons associated with the business at the location of the user. The user may select the coupon from the list. Alternatively, the user may select the coupon from a list of all stored coupons.

After selecting the coupon the user indicates that the merchant is ready to verify the coupon. The CDS checks the visual verification pattern that the merchant has configured for the current coupon. The exemplary embodiments would strive to produce a pattern that can quickly, efficiently, and securely be identified by the merchant.

Typical patterns may be a combination of a shape and a color. Additionally, a colored shape may be inside an outer shape. For example, the pattern may be a blue star in a circle. One skilled in the art would recognize that any shape, picture, or other visual image could be employed in the invention. The pattern may need to be of sufficient complexity to limit unauthorized reproduction for the purposes of fraud.

The CDS transfers the pattern to the user device. In a certain embodiment of the invention, the pattern may have a timer function attached. Limiting the time that the user may display the coupon may serve to prevent repeated redemption of the same coupon instance.

The user displays the pattern to the merchant for verification. In an exemplary embodiment, the user can simply show the mobile device to the merchant for a visual verification that the pattern being displayed corresponds to a coupon being offered by the merchant. The merchant may have trained the salespeople to recognize verification patterns and to apply the corresponding coupon. Throughout the specification, the term “salesperson” or “salespeople” should be interpreted to include any merchant employ, merchant owner, checkout worker, or any other person working at the merchant location that may operate the point of sale terminal and assist a customer with product purchase and coupon redemption.

The merchant applies the coupon to the purchase and the merchant system reports the coupon usage to the CDS. The CDS notes the coupon as redeemed. Depending on the restrictions of the coupon, the CDS can perform the steps required. For example, the CDS can discontinue verification of the coupon for the user, report to the product manufacturer the coupon usage, send a report to the user, or any other action a redeemed coupon requires.

The digital wallet and the CPA can be embodied as stand-alone application programs or as companion programs to a web browser, for example, as a companion program to a Hypertext Markup Language revision 5 (“HTML5”) compliant web browser or other type of web browser having messaging and storage capabilities. While certain embodiments are described in which parts of the digital wallet and the receipt module are implemented in software, it will be appreciated that one or more acts or functions of the digital wallet and the receipt module may be performed by hardware, software, or a combination thereof, as may be embodied in one or more computing systems.

The functionality of the exemplary embodiments will be explained in more detail in the following description, read in conjunction with the figures illustrating the program flow.

### System Architecture

Turning now to the drawings, in which like numerals represent like (but not necessarily identical) elements throughout the figures, exemplary embodiments of the present invention are described in detail.

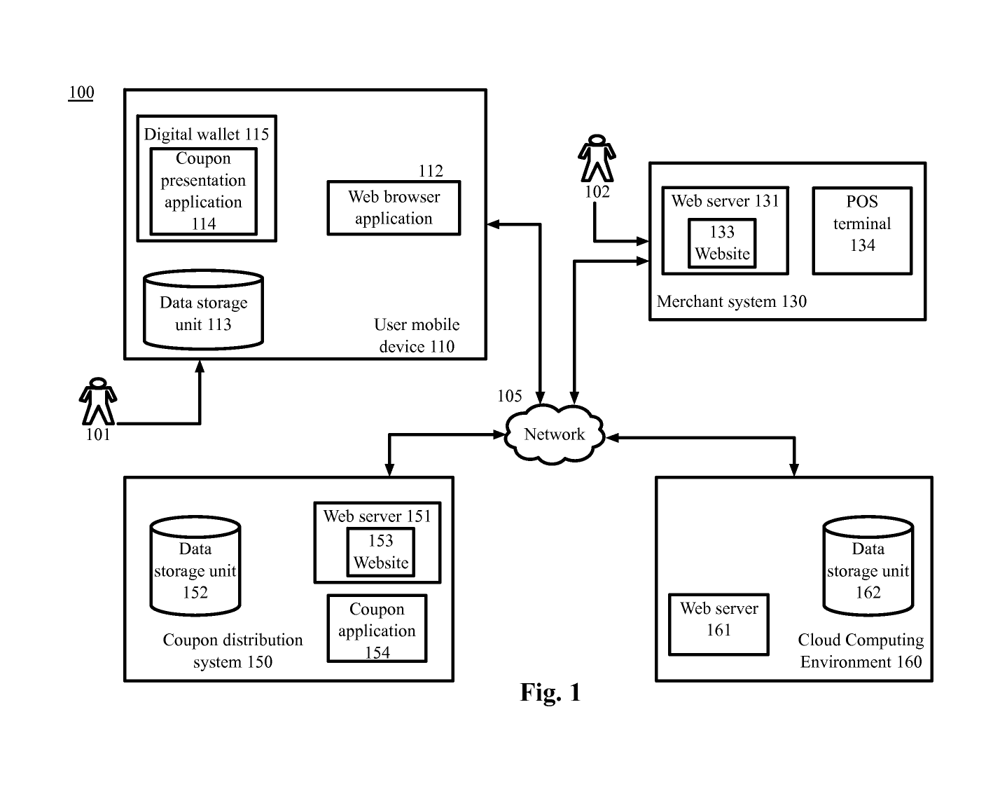

FIG. 1 is a block diagram depicting a system 100 for using a visual pattern for coupon redemption via a mobile device, in accordance with certain exemplary embodiments.

Referring to FIG. 1, the exemplary operating environment 100 includes a merchant system 130, a coupon distribution system (“CDS”) 150, a cloud computing environment 160, and a user device 110 associated with a user 101. The user device 110 may be a mobile device, (for example, notebook computer, tablet computer, netbook computer, personal digital assistant (PDA), video game device, GPS locator device, cellular telephone, smartphone, or other mobile device), or other appropriate technology that includes or is coupled to a web browser application module 112, such as GOOGLE'S CHROME, MICROSOFT'S INTERNET EXPLORER®, or MOZILLA'S FIREFOX®.

In certain exemplary embodiments, the web browser application 112 is an HTML5 compliant web browser. HTML5 compliant web browsers include a cross-document messaging application programming interface (API) and a local storage API that previous HTML versions did not have. The cross-document messaging API of HTML5 compliant web browsers enables documents, such as web pages, to communicate with each other. For example, a first document can send a message to a second document requesting information. In response, the second document can send a message including the requested information to the first document. The local storage API of HTML5 compliant web browsers enables the web browser to store information on a client device upon which the web browser is installed or is executing, such as the user device 110. Websites also can employ the local storage API to store information on a client device. Other web browsers having cross-document messaging and/or local storage capabilities also may be used in certain exemplary embodiments.

The user 101 can use the web browser application 112 to view, download, upload, or otherwise access documents or web pages via a distributed network 105. The network 105 includes a wired or wireless telecommunication system or device by which network devices (including devices 110, 130, 150, and 160) can exchange data. For example, the network 105 can include a local area network (“LAN”), a wide area network (“WAN”), an intranet, an Internet, or any combination thereof. Throughout the discussion of exemplary embodiments, it should be understood that the terms “data” and “information” are used interchangeably herein to refer to text, images, audio, video, or any other form of information that can exist in a computer based environment.

The web browser application 112 can interact with web servers (or other computing devices) connected to the network 105, such as web server 131 of the merchant system 130, web server 151 of the CDS 150, and the web server 161 of the cloud computing environment 160.

The user device 110 may include a digital wallet application 111. The digital wallet 111 may encompass any application, hardware, software, or process the user device 110 may employ to assist the user 101 in completing a purchase. The digital wallet 111 can interact with the web browser application 112 or can be embodied as a companion application of the web browser application 112. As a companion application, the digital wallet 111 executes within the web browser application 112. That is, the digital wallet 111 may be an application program embedded in the web browser application 112.

The user device 110 can include a coupon presentation application (“CPA”) 115. The CPA 115 can interact with the web browser application 112 or be embodied as a companion application of the web browser application 112 and execute within the web browser application 112. The CPA 115 may further be embodied as a companion application of the digital wallet 111 and execute within the digital wallet 111. The CPA 115 may employ a software interface for configuration that may open in the digital wallet application 111 or may open in the web browser application 112.

The CPA 115 is operable to allow a user 101 to select a stored coupon, receive the visual redemption pattern of the coupon, and display the pattern to the merchant 130. The CPA 115 is further operable to store coupons in a data storage unit 113 stored on or coupled to the user device 110 or at a cloud computing environment 160.

The user device 110 also includes a data storage unit 113 accessible by the digital wallet 111, the CPA 115, and the web browser application 112. The exemplary data storage unit 113 can include one or more tangible computer-readable storage devices. The data storage unit 113 can be stored on the user device 110 or can be logically coupled to the user device 110. For example, the data storage unit 113 can include on-board flash memory and/or one or more removable memory cards or removable flash memory.

The merchant system 130 may include a web server 131 and a website 133. The merchant system 130 includes a point of sale (“POS”) terminal 134 that may be logically coupled to the web server 131 of the merchant system 130. The POS terminal 132 may be operated by a salesperson 102 that enters the purchase data and the coupon data into the POS terminal 132 to complete the purchase transaction.

The cloud computing environment 160 includes the web server 161 and one or more data storage units 162. The cloud computing environment 160 may be provided by the provider of the digital wallet, by a provider of the mobile device, or by another party. In certain exemplary embodiments, multiple cloud computing environments 160 may be employed. For example, a first cloud computing environment may store coupon information and provide access to the coupons from a user device 110 connected to the first cloud computing, and a second cloud computing environment may provide security information, such as lists of non-trusted merchants, to the digital wallet 111. Although the illustrated environment includes a cloud computing environment, other types of computing environments, such as a client-server environment may be used instead.

The CDS 150 is a system to create, distribute, track, validate, or issue coupons to users 101. The CDS 150 may be an independent distributor, a function of a product manufacturer, a product marketer, or any other system or organization that may distribute coupons. The CDS 150 may be a function of the redeeming merchant system 130. The CDS 150 includes the web server 151, one or more data storage units 152, and a coupon application 154. The CDS 150 may include any provider of online coupons to the user 101. The coupons may be delivered to the user device 110 or any other online presence of the user 101. Examples of coupon delivery methods might include, but would not be limited to, pop-up advertisements, rollover advertisements, banner advertisements, daily deal coupons, emails, text, instant messaging, advertisements in applications, or any other coupon advertising and delivery service.

The coupon application 154 on the CDS 150 can maintain a coupon account for each user, including the user 101. This coupon account can store (in the data storage unit 152) the coupons selected by the user 101 and also the related coupon information configured by the merchant system 130 or by the CDS 130. The coupon application 154 can synchronize this information with the digital wallet 111 periodically, on command (for example, by the user 101), or in response to an update in information at the digital wallet 111 or at the cloud computing environment 160.

The CPA 115, digital wallet 111, and the web browser application 112 can interact with the coupon application 154 via the web server 161. The coupon application 154 can provide a user interface via the web server 151 that enables the user 101 to access, view, and/or modify content stored in the user's coupon account using the user device 110 or another device connected to the network 105. The digital wallet 111 can include a user interface for accessing coupon information stored on the user device 110 or at the cloud computing environment 160 in a meaningful and useful way.

It will be appreciated that the network connections shown are exemplary and other means of establishing a communications link between the computers and devices can be used. Moreover, those having ordinary skill in the art having the benefit of the present disclosure will appreciate that the merchant system 130, CDS 150, cloud computing environment 160, and the user device 110 illustrated in FIG. 1 can have any of several other suitable computer system configurations. For example a user device 110 embodied as a mobile phone or handheld computer may not include all the components described above.

### System Process

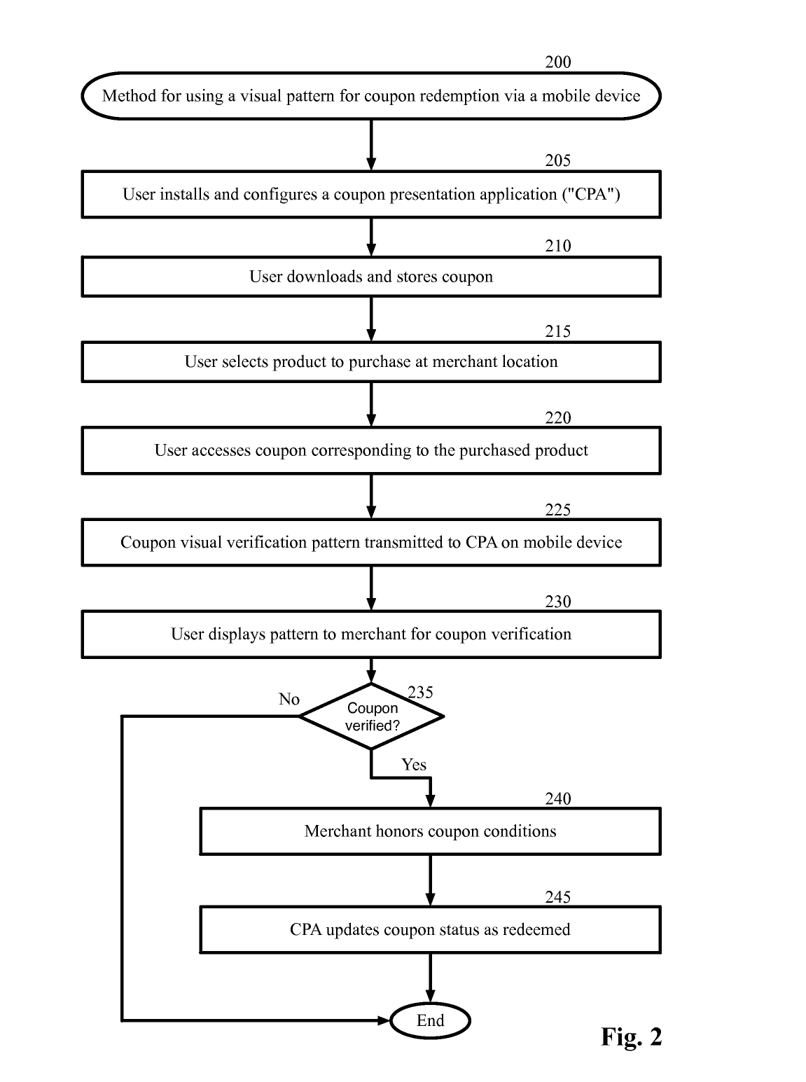

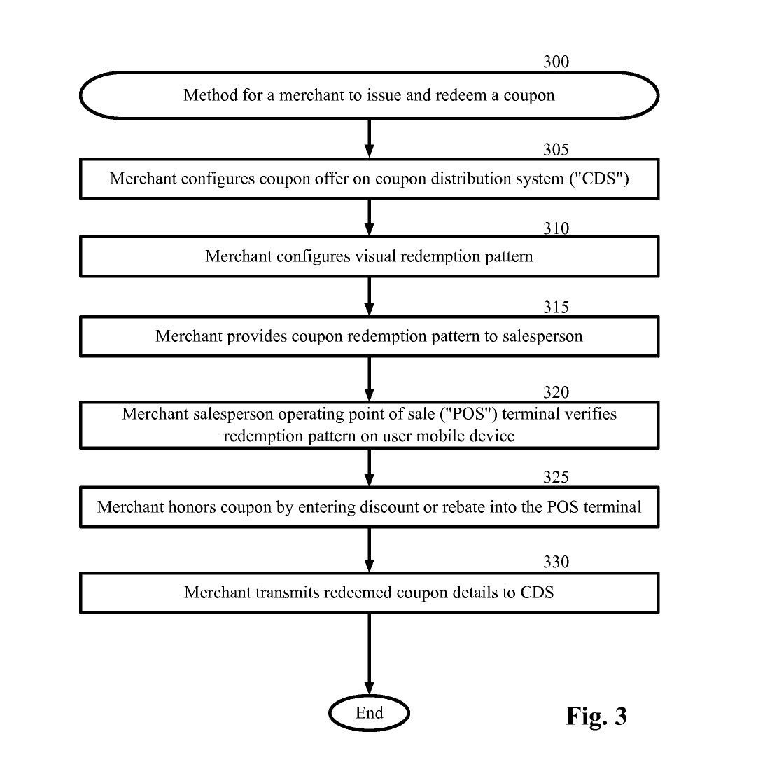

The components of the exemplary operating environment 100 are described hereinafter with reference to the exemplary methods illustrated in FIGS. 2-3. The exemplary embodiments can include one or more computer programs that embody the functions described herein and illustrated in the appended flow charts. However, it should be apparent that there could be many different ways of implementing aspects of the exemplary embodiments in computer programming, and these aspects should not be construed as limited to one set of computer instructions. Further, a skilled programmer would be able to write such computer programs to implement exemplary embodiments based on the flow charts and associated description in the application text. Therefore, disclosure of a particular set of program code instructions is not considered necessary for an adequate understanding of how to make and use the exemplary embodiments. Further, those skilled in the art will appreciate that one or more acts described may be performed by hardware, software, or a combination thereof, as may be embodied in one or more computing systems.

FIG. 2 is a block flow diagram depicting a method 200 to use a visual pattern for coupon redemption via a mobile device 110, in accordance with certain exemplary embodiments. With reference to FIGS. 1 and 2, in block 205, the provider of the CPA 115 may install computer-readable program instructions on the CDS 160 for interacting with the user 101 on any user device, including the user device 110. In an exemplary embodiment, these computer-readable program instructions may be implemented as an embedded script, such as JavaScript, in the application server. The instructions installed on the CDS 160 may allow the CDS 160 to communicate via a user interface with the user 101 to configure a CPA 115. CPA 115 configuration may include any information required by a user 101 to use a coupon with a mobile device 110. This information may include, but would not be limited to, coupon information, merchant 130 locations, merchant 130 coupon restrictions, verification pattern processes, or other information that would assist the user 101 in redeeming a coupon.

In block 210, in the exemplary embodiment of the invention, a user 101 downloads and stores coupons on the CPA 115. The user 101 may obtain the coupons through any available means for acquiring coupons. In one embodiment, the coupons may be from an online advertisement such as a banner ad or a popup ad. In another embodiment, the coupons may be from a pre-pay or daily deal type coupons system. In another embodiment, the coupons may be received via email, text, instant message or some other coupon distribution technology. The coupons may alternatively be stored on the user account on the CDS 150 or on the cloud computing environment 160.

In block 215, the user 101 selects products to purchase at a physical merchant 130 location. The merchant 130 location may be a physical store or marketplace. The product may be taken to a POS terminal 134 for checkout.

In block 220, the user 101 can initiate the CPA 115 to access the coupon. In certain exemplary embodiments of the invention, the CPA 115 can transmit the location of the user 101 to the CDS 150 and the CDS 150 can identify a coupon or a list of coupons associated with the merchant 130 at the location of the user 101. The user device 110 may utilize the Global Positioning System (“GPS”) to determine its location or any other location identifying application or hardware. The user 101 may select the coupon from the list.

Additionally or alternatively, the user 101 may access a list of all stored coupons and choose the preferred coupon from the list. In an alternate embodiment of the invention, the CDS 150 may identify the location of the user 101 after coupon selection to ensure that the user 101 is in the correct location. The CDS 150 may only present the redemption pattern if the user 101 is in the correct location for the corresponding coupon.

Additionally or alternative, the user 101 may view the coupon after arriving at the location of the merchant 130. For example, the merchant 130 may be advertising a coupon of which the user 101 was not previously aware, the coupon promotion may have just started, the merchant 130 may only promote the coupon to users 101 that have entered the location, or for any other reason the user 101 has not previously stored the coupon. The user 101 may employ the user device 110 to access and store the coupon from the location of the merchant 130. For example, the user device 110 may access the coupon over the Internet using a network 105 connection or the user device 110 may access the coupon via a communication with the POS terminal 134 such as NFC or BLUETOOTH. The user device 110 may use any other communication technology previously discussed to access and store the coupon.

After accessing and storing the coupon, the user 101 may proceed with the method 200 in a similar manner as if the user 101 had downloaded the coupon before entering a location of a merchant 130.

In block 225, after selecting the coupon for use with the present purchase, the user 101 indicates that the merchant 130 is ready to verify the coupon. The CDS 150 accesses the visual verification pattern that the merchant 130 has configured for the current coupon. The exemplary embodiments would strive to produce a pattern that can be quickly, efficiently, and securely identified by the merchant 130. The merchant 130 may configure the pattern in the CDS 150. During configuration, the merchant 130 may pick from a library of patterns or create a custom pattern. The merchant 130 may additionally configure a series of patterns that may change at a given schedule. For example, for a daily special, a merchant 130 may have a month of patterns that change every day.

Typical patterns may be a combination of a shape and a color. Additionally, a colored shape may be inside an outer shape. For example, the pattern may be a blue star in a circle. One skilled in the art would recognize that any shape, picture, or other visual image could be employed in the invention. The pattern may need to be of sufficient complexity to limit unauthorized reproduction for the purposes of fraud.

The CDS 150 transfers the verification pattern to the user device 110. In a certain embodiment of the invention, the pattern may have a timer function attached. Limiting the time that the user 101 may display the coupon may serve to prevent repeated redemption of the same coupon instance.

The CPA 115 receives the verification pattern and alerts the user 101 that the pattern is available and ready for display. If the coupon has a time limit on the display of the pattern, the user 101 can verify that the salesperson 102 of the merchant 130 is ready to visually verify the coupon.

In block 230, the user 101 displays the pattern to the salesperson 102 for verification. In an exemplary embodiment, the user 101 can simply show the mobile device 110 to the merchant for a visual verification that the pattern being displayed corresponds to a coupon being offered by the merchant. The merchant 130 may have trained the salespeople 102 to recognize verification patterns and to apply the corresponding coupon. Alternatively, the merchant 130 may provide the salesperson 102 another manner of verifying the pattern such as a display on the POS terminal 134 that is visible to the salesperson 102.

In block 235, the salesperson 102 determines if the pattern displayed by the user device 110 corresponds to a coupon for a product that the user 101 is purchasing. If the salesperson 102 verifies the coupon, the method 200 follows the “YES” branch to block 240. Otherwise, if the coupon is not verified, the method 200 follows the “NO” branch to the end of the method 200.

Following the “YES” branch to block 240, the salesperson 102 enters the coupon into the POS terminal 134. The POS terminal 134 will apply the coupon to the transaction.

In block 245, the merchant system 130 reports the coupon usage to the CDS 150. The CDS 150 notes the coupon as redeemed. The CDS 150 can perform the steps required by the coupon restrictions. For example, the CDS 150 can discontinue verification of the coupon for the user 101, report the coupon usage to the product manufacturer, send a report to the user 101, or any other action a redeemed coupon requires.

From block 245, the method 200 ends.

FIG. 3 is a flow chart depicting a method 230 to allow a merchant to issue and redeem a coupon, in accordance with certain exemplary embodiments.

With reference to FIGS. 1 and 3, in block 305, in the exemplary embodiment, the merchant 130 configures coupon offers on the CDS 150. The merchant 130 may configure a coupon to be distributed to users 101. One skilled in the art would recognize that coupons might be configured by product manufactures, product marketing organizations, advertising groups, or any other entity that would benefit from giving a user 101 an incentive to purchase a product. Throughout the specification, the term “merchant” should be interpreted to include all entities that might configure or redeem a coupon.

In block 310, after configuring the details of the coupon incentive, the merchant 130 may pick from a library of patterns or create a custom pattern for redemption. The merchant 130 may additionally configure a series of patterns that may change at a given schedule. For instance, for a daily special, a merchant 130 may have a month of patterns that change every day.

Typical patterns may be a combination of a shape and a color. Additionally, a colored shape may be inside an outer shape. For example, the pattern may be a blue star in a circle. One skilled in the art would recognize that any shape, picture, or other visual image could be employed in the invention. The pattern may need to be of sufficient complexity to limit unauthorized reproduction for the purposes of fraud.

If at any time, the merchant 130 feels that the verification pattern has been compromised, the merchant 130 may change the verification pattern in the CDS 150. For example, if a user 101 has identified the pattern currently being used and creates a fraudulent visual pattern that replicates the pattern of the coupon, then the merchant 130 may desire to change the pattern. Because the CDS 150 transmits the verification pattern at the time of usage, the change of pattern may take place instantaneously. After the pattern change, subsequent coupon user's 101 can receive the new pattern.

In an alternate embodiment, the CDS 150 may establish the pattern associated with the coupon. The CDS 150 may choose a pattern, associate the pattern with the coupon, and transmit the pattern to the merchant 130. The merchant 130 can receive from the CDS 150 the pattern associated for use in confirming the display on the user device 110.

In block 315, the merchant 130 may train the salespeople 102 to recognize verification patterns and to apply the corresponding coupon. Alternatively, the merchant 130 may have another means of verifying the pattern such as a display on the POS terminal 134 that is visible to the salesperson 102. A simple picture of the verification pattern being utilized that day may be kept at the POS terminal 134 for reference. Any other process that allows the salesperson 102 to recognize and verify the pattern displayed by the user 101 may be utilized.

In block 320, the salesperson 102 verifies the pattern displayed by a user 101 making a purchase.

In block 325, the salesperson 102 honors the details of the coupon and inputs the data into the POS terminal 134.

In block 330, the merchant system 130 reports the coupon usage to the CDS 150. From block 330, the method 300 ends.

### General

Users may be allowed to limit or otherwise affect the operation of the features disclosed herein. For example, users may be given opportunities to opt-in or opt-out of the collection or use of certain data or the activation of certain features. In addition, users may be given the opportunity to change the manner in which the features are employed, including for situations in which users may have concerns regarding privacy. Instructions also may be provided to users to notify them regarding policies about the use of information, including personally identifiable information, and manners in which each user may affect such use of information. Thus, information can be used to benefit a user, if desired, through receipt of relevant advertisements, offers, or other information, without risking disclosure of personal information or the user's identity.

One or more aspects of the exemplary embodiments may include a computer program that embodies the functions described and illustrated herein, wherein the computer program is implemented in a computer system that comprises computer-readable/computer-executable instructions stored in a machine-readable medium and a processor that executes the instructions. However, it should be apparent that there could be many different ways of implementing the exemplary embodiments in computer programming, and the exemplary embodiments should not be construed as limited to any one set of computer program instructions. Further, a skilled programmer would be able to write such a computer program to implement an embodiment based on the appended flow charts and associated description in the application text. Therefore, disclosure of a particular set of program code instructions is not considered necessary for an adequate understanding of how to make and use the exemplary embodiments. Moreover, any reference to an act being performed by a computer should not be construed as being performed by a single computer as more than one computer may perform the act.

The exemplary systems, methods, and acts described in the embodiments presented previously are illustrative, and, in alternative embodiments, certain acts can be performed in a different order, in parallel with one another, omitted entirely, and/or combined between different exemplary embodiments, and/or certain additional acts can be performed, without departing from the scope and spirit of the invention. Accordingly, such alternative embodiments are included in the inventions described herein.

The exemplary embodiments described herein can be used with computer hardware and software that perform the methods and processing functions described previously. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

Although specific embodiments have been described above in detail, the description is merely for purposes of illustration. It should be appreciated, therefore, that many aspects described above are not intended as required or essential elements unless explicitly stated otherwise. Modifications of, and equivalent acts corresponding to, the disclosed aspects of the exemplary embodiments, in addition to those described above, can be made by a person of ordinary skill in the art, having the benefit of the present disclosure, without departing from the spirit and scope of the invention defined in the following claims, the scope of which is to be accorded the broadest interpretation so as to encompass such modifications and equivalent structures.

What is claimed is:

1. A computer-implemented method to use a visual verification pattern on a mobile device to redeem a coupon, comprising:
associating, by a computer, a coupon for a product with a record of a user;
receiving, by the computer, a request from a user network device associated with the user to redeem the coupon;
identifying, by the computer, a visual verification pattern for the coupon;
transmitting, by the computer, the visual verification pattern to the user network device for display on the user network device for visual verification of the coupon by a merchant; and
updating, by the computer, a status of the coupon in the record to indicate that the coupon has been redeemed.

2. The computer-implemented method of claim 1, further comprising:
receiving, by an application executing on the user network device, the visual verification pattern; and
displaying, by the application executing on the user network device, the visual verification pattern on the user network device for visual verification of the coupon by the merchant.

3. The computer-implemented method of claim 1, further comprising:
selecting, by the computer, the visual verification pattern to associate with the coupon;
associating, by the computer, the visual verification pattern with the coupon; and
transmitting, by the computer, the visual verification pattern associated with the coupon to the merchant.

4. The computer-implemented method of claim 1, further comprising receiving, by the computer, confirmation, from a computer associated with the merchant, of redemption of the coupon by the merchant based on the visual verification pattern,
wherein the updating step is performed in response to receiving the confirmation.

5. The computer-implemented method of claim 1, wherein the updating step is performed in response to transmitting the visual verification pattern to the user network device.

6. The computer-implemented method of claim 1, wherein the request to redeem the coupon comprises a request to communicate the verification pattern associated with the coupon to the user network device.

7. The computer-implemented method of claim 1, further comprising:
receiving, by the computer, an input of a configuration of the visual verification pattern from a computer associated with a merchant; and
associating the input visual verification pattern with the coupon.

8. The computer-implemented method of claim 1, wherein the computer is a server operating on a coupon distribution system.

9. The computer-implemented method of claim 1, wherein the associating of the coupon is performed on the user network device.

10. The computer-implemented method of claim 1, further comprising:
receiving a location of the user network device and accessing a list of one or more coupons associated with the location; and
transmitting the list of coupons to the user network device,
wherein the coupon is included in the accessed coupons, and
wherein the request includes a selection of the coupon from the list of coupons.

11. The computer-implemented method of claim 1, further comprising:
receiving, by the computer, a location of the user network device;
determining, by the computer, whether the location of the user network device corresponds to location information provided by the merchant for redemption of the coupon; and
declining, by the computer, to transmit the verification pattern to the user network device in response to determining that the location of the user network device does not correspond to the location information provided by the merchant for coupon redemption.

12. The computer-implemented method of claim 1, further comprising:
determining whether the record includes an indication that the coupon has previously been redeemed; and
declining to transmit the visual verification pattern to the user network device in response to a determination that the record includes an indication that the coupon has previously been redeemed.

13. The computer-implemented method of claim 1, further comprising:
determining whether the coupon has previously been redeemed a predetermined number of times for the merchant; and
declining to transmit the visual verification pattern to the user network device in response to a determination that the coupon has previously been redeemed the predetermined number of times for the merchant.

14. A computer program product, comprising:
a non-transitory, computer-readable storage medium having computer-executable program instructions embodied therein for using a visual verification pattern on a mobile device to redeem a coupon, the computer-readable program instructions comprising:
computer-readable program code for associating a visual verification pattern with an offer for a product;
computer-readable program code for receiving a request from a user network device to redeem the offer; and
computer-readable program code for transmitting the visual verification pattern to the user network device for display on the user network device for visual verification of the offer by a merchant in connection with redemption of the offer by the merchant.

15. The computer program product of claim 14, wherein the computer-readable program instructions further comprise computer-readable program code for updating a status of the offer in a record associated with a user of the user network device to indicate that the offer has been redeemed by the user.

16. The computer program product of claim 14, wherein the computer-readable program instructions further comprise:
computer-readable program code to receive a location of the user network device and to access a list of one or more coupons associated with the location;
computer-readable program code to transmit the accessed coupons to the user network device; and
computer-readable program code to receive the identity of the selected coupon from the user network device.

17. The computer program product of claim 14, further comprising computer-readable program code to receive confirmation, from a computer associated with the merchant, of redemption of the coupon by the merchant based on the visual verification pattern,
wherein the updating step is performed in response to receiving the confirmation.

18. The computer program product of claim 15, wherein the updating step is performed in response to transmitting the visual verification pattern to the user network device.

19. The computer program product of claim 14, wherein the request to redeem the coupon comprises a request to communicate the verification pattern associated with the coupon to the user network device.

20. The computer program product of claim 14, further comprising:
computer-readable program code to receive an input of a configuration of the visual verification pattern from a computer associated with a merchant; and
computer-readable program code to associate the input visual verification pattern with the coupon.

21. The computer program product of claim 14, wherein the computer is a server operating on a coupon distribution system.

22. The computer program product of claim 14, wherein the associating of the coupon is performed on the user network device.

23. The computer program product of claim 14, further comprising:
computer-readable program code to receive a location of the user network device and accessing a list of one or more coupons associated with the location; and
computer-readable program code to transmit the list of coupons to the user network device,
wherein the coupon is included in the accessed coupons, and
wherein the request includes a selection of the coupon from the list of coupons.

24. The computer program product of claim 14, further comprising:
computer-readable program code to receive a location of the user network device;
computer-readable program code to determine whether the location of the user network device corresponds to location information provided by the merchant for redemption of the coupon; and
computer-readable program code to decline to transmit the verification pattern to the user network device in response to determining that the location of the user network device does not correspond to the location information provided by the merchant for coupon redemption.

25. The computer program product of claim 14, further comprising:
computer-readable program code to determine whether the record includes an indication that the coupon has previously been redeemed; and
computer-readable program code to decline to transmit the visual verification pattern to the user network device in response to a determination that the record includes an indication that the coupon has previously been redeemed.

26. The computer program product of claim 14, further comprising:
computer-readable program code to determine whether the coupon has previously been redeemed a predetermined number of times for the merchant; and
computer-readable program code to decline to transmit the visual verification pattern to the user network device in response to a determination that the coupon has previously been redeemed the predetermined number of times for the merchant.

27. A system for generating a visual verification pattern on a mobile device to redeem a coupon, comprising:
a computer configured to:
associate a coupon for a product with a record of a user;
receive a request from a user network device associated with the user to redeem the coupon;
identify a visual verification pattern for the coupon;
transmit the visual verification pattern to the user network device for display on the user network device for visual verification of the coupon by a merchant; and
update a status of the coupon in the record to indicate that the coupon has been redeemed.

28. The system of claim 27, further comprising:
a user network device;
a user network device storage resource; and
a user device processor communicatively coupled to the user device storage resource and the user device network module, wherein the processor executes application code instructions that are stored in the storage resource and that cause the system to:
receive the visual verification pattern; and
display the visual verification pattern on the user network device for visual verification of the coupon by the merchant.

29. The system of claim 27, the computer further configured to receive confirmation, from a computer associated with the merchant, of redemption of the coupon by the merchant based on the visual verification pattern,
wherein the updating step is performed in response to receiving the confirmation.

30. The system of claim 27, wherein the updating step is performed in response to transmitting the visual verification pattern to the user network device.

31. The system of claim 27, wherein the request to redeem the coupon comprises a request to communicate the verification pattern associated with the coupon to the user network device.
